(19) United States
(12) Patent Application Publication
(10) Pub. No.: US 2024/0427100 A1
(43) Pub. Date: Dec. 26, 2024

(54) CABLE SEAL

(71) Applicant: CommScope Technologies LLC, Hickory, NC (US)

(72) Inventors: Barry Wayne ALLEN, Siler City, NC (US); William B. BRYAN, Fuquay-Varina, NC (US); Roy Keller THOMPSON, Apex, NC (US)

(73) Assignee: CommScope Technologies LLC, Hickory, NC (US)

(21) Appl. No.: 18/686,949

(22) PCT Filed: Aug. 24, 2022
(86) PCT No.: PCT/US2022/041394

§ 371 Date: Feb. 27, 2024

Related U.S. Application Data
(60) Provisional application No. 63/237,864, filed on Aug. 27, 2021.

(51) Int. Cl. G02B 6/44

(52) U.S. Cl. CPC G02B 6/44465

(57) ABSTRACT

The present disclosure relates to a cable seal for use in a telecommunications enclosure. The cable seal can include various features such as an offset actuator for pressurizing the seal, a latch for securing the seal in a pocket of an enclosure, a gel containment extension for covering a portion of a perimeter of a volume of gel of the seal, a gel interlock feature and/or a feature for adjusting the gel volume of the seal.

### CROSS-REFERENCE TO RELATED APPLICATION

This application is being filed on Aug. 24, 2022 as a PCT International Patent Application and claims the benefit of U.S. Patent Application Ser. No. 63/237,864, filed on Aug. 27, 2021, the disclosure of which is incorporated herein by reference it its entirety.

### TECHNICAL FIELD

The present disclosure relates generally to telecommunication systems. More particularly the present disclosure relates to a cable seal for use in a telecommunication system.

### BACKGROUND

Telecommunications systems typically employ a network of telecommunications cables capable of transmitting large volumes of data and voice signals over relatively long distances. The telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures are adapted to house and protect telecommunications components such as optical splices, fiber optic adapters, fiber management structures such as trays, termination panels, power splitters, and wavelength division multiplexers. It is often preferred for the telecommunications enclosures to be re-enterable. The term “re-enterable” means that the telecommunications enclosures can be re-opened to allow access to the telecommunications components housed therein without requiring the removal and destruction of the telecommunications enclosures. Telecommunications enclosures also often include cable seals for sealing locations where cables enter/exit the enclosures. Example prior art patent publications disclosing re-enterable telecommunications enclosures with cable sealings include: U.S. Pat. Nos. 9,250,407; 8,989,550; 8,718,434; 10,288,829; 10,935,135; 10,371,912; and PCT International Publication No. WO2020/061283.

### SUMMARY

One aspect of the present disclosure relates to a cable seal having a volume of sealing gel and a pressurization arrangement for pressurizing the volume of sealing gel. The pressurization arrangement includes an actuator for selectively pressurizing and the pressurizing the volume of gel. The actuator includes a pressurization shaft that is asymmetrically (e.g., non-centered) positioned relative to the volume of sealing gel. The pressurization arrangement can include reinforcing structures such as gussets to facilitate relatively uniform pressurization of the sealing gel.

Another aspect of the present disclosure relates to a cable seal having a volume of sealing gel and a pressurization arrangement for pressurizing the volume of sealing gel. The pressurization arrangement includes first and second pressurization plates between which the volume of sealing gel is positioned. The pressurization arrangement also includes an actuator for forcing the first and second pressurization plates together to pressurize the volume of sealing gel. The cable seal is adapted to be mounted within a pocket of an enclosure and includes a latch for securing the cable seal within the pocket. In one example, the latch is integrated with one of the first and second pressurization plates. In one example, the cable seal is inserted downwardly into the pocket and latched into place within the pocket. Once latched into place, the cable seal is prevented from moving upwardly out of the pocket unless unlatched. In one example, the enclosure is a re-enterable defined by a first housing piece including the pocket and a second housing piece that mounts to the first housing piece at a perimeter interface sealed by a perimeter seal. In one example, the perimeter seal extends across a top side of the cable seal when the cable seal is mounted within the pocket and the first and second housing pieces are secured together. In one example, the pressurization arrangement includes a cover that covers a top side of the cable sealing gel. The cover provides containment of the cable sealing gel at the top side of the cable sealing gel. The first and second pressurization plates provide containment of the cable sealing gel at front and back major faces of the cable sealing gel. When the cable seal is mounted within the pocket, sides, and a bottom portion of the volume of sealing gel which extend about a perimeter of the cable sealing gel contact and seal against portions of the enclosure defining the pocket. The perimeter seal provides sealing between the first and second housing pieces and extends across a top side of the cover covering the top side of the cable sealing gel. When the cable seal is latched within the pocket and pressurized, the volume of cable sealing gel is contained at the front and back axial faces of the cable sealing gel by the first and second pressurization structures and contained at the sides and bottom of the perimeter of the cable sealing gel by the enclosure and is contained at the top of the perimeter of the cable sealing gel by the cover provided by the pressurization arrangement. With this type of configuration, the cable seal can be effectively pressurized when latch within the pocket even when the first and second housing pieces are not coupled together. Further, when the cable seal is pressurized and the housing is opened to enter the interior the housing by separating the first and second housing pieces from one another, the cable seal is not de-pressurized. Instead, the volume of cable sealing gel remains fully contained. In certain examples, the top cover provided by the pressurization arrangement provides an upper sealing surface against which the perimeter seal for sealing between the first and second housing piece effectively seals. The top cover also provides an effective transition of the perimeter seal across triple points at the top of the cable seal where the perimeter seal transitions from the cable seal to a channel defined by one of the first or second housing pieces. During pressurization, small portions of the cable sealing gel can extrude into the triple point regions at ends of the top cover to enhance sealing at the triple point regions.

Another aspect of the present disclosure relates to a cable seal having a volume of sealing gel and a pressurization arrangement for pressurizing the volume of sealing gel. The pressurization arrangement includes first and second pressurization plates between which the volume of sealing gel is positioned. The pressurization arrangement also includes an actuator for forcing the first and second pressurization plates together to pressurize the volume of sealing gel. In one example, the pressurization arrangement includes a cover that covers a top side of the cable sealing gel. The cover provides containment of the cable sealing gel at the top side of the cable sealing gel and can provide a surface against which a perimeter seal of the enclosure can seal. The cover can be adapted to enhance sealing at triple points defined at interfaces between the housing and the cable seal. In one example, the cover can include at least one extension integrated with at least one of the first and second pressurization plates. In one example, the cover can include first and second extensions respectively integrated with the first and second pressurization plates. In one example, the first and second extensions can overlap one another and can slide relative to one another as the pressurization arrangement is actuated and de-actuated.

Another aspect of the present disclosure relates to a cable seal having a volume of sealing gel and a pressurization arrangement for pressurizing the volume of sealing gel. The pressurization arrangement includes first and second pressurization plates between which the volume of sealing gel is positioned. The pressurization arrangement also includes an actuator for forcing the first and second pressurization plates together to pressurize the volume of sealing gel. In one example, the volume of cable sealing gel includes a length that extends between first and second ends and includes first and second cable pass-through locations spaced apart from one another along the length. The second cable pass-through location is located adjacent the second end of the volume of cable sealing gel. The volume of cable sealing gel includes a main body and an access portion coupled to the main body. The access portion defines a portion of the cable pass-through location and is capable of being flexed away from the main body from a first position to a second position to provide lateral cable access to the second cable pass-through location. The access portion includes an interlock portion that fits in a receptacle defined by at least one of the first and second pressurization plates to retain the access portion in the first position when the volume of sealing gel is assembled between the first and second pressurization plates. In certain examples, interlock portions are provided at opposite major first and second faces of the volume of cable sealing gel. The interlock portions preferably extend in axial directions (e.g., in directions parallel to axes that extend through the cable pass-through locations) so as to be capable of being received within corresponding receptacles defined by the pressurization plates. In certain examples, the interlock structures are positioned adjacent to an outer perimeter of the second cable pass-through location. In certain examples, the interlock structures can each include a first section integrated with the access portion of the cable sealing gel and a second section integrated with the main body of the volume of cable sealing gel. In certain examples, the interlock structures can be configured to extend around the second cable pass-through location. In certain examples, the interlock structures can be configured as blocks, tabs, rings, cylinders, lips or other structures. In certain examples, and interlock structure can be located adjacent a slit defined through the volume of cable sealing gel from a perimeter of the volume of cable sealing gel to the second cable pass-through location. In certain examples, the interlocks do not cover the cable pass-through location. In other examples, the volume of cable sealing gel may include only one cable pass-through location, and one or more interlocks can be provided on an access portion that is movable to provide lateral access to the pass-through location such that the volume of cable sealing gel has a wrap-around configuration for allowing the volume of cable sealing gel to be wrapped around a cable during installation of the cable through the volume of cable sealing gel.

Another aspect of the present disclosure relates to a cable seal having a volume of sealing gel and a pressurization arrangement for pressurizing the volume of sealing gel. The pressurization arrangement includes first and second pressurization plates between which the volume of sealing gel is positioned. The pressurization arrangement also includes an actuator for forcing the first and second pressurization plates together to pressurize the volume of sealing gel. In one example, the volume of cable sealing gel includes a length that extends between first and second ends and includes first and second cable pass-through locations spaced apart from one another along the length. The second cable pass-through location is located adjacent the second end of the volume of cable sealing gel. In one example, the volume of cable sealing gel includes a flap that extends about the second cable pass-through location and is located between the second cable pass-through location and the second end of the volume of cable sealing gel. The flap is removable from a main body of the volume of cable sealing gel. When the flap is attached to the main body of the volume of cable sealing gel, the volume of cable sealing gel is adapted to accommodate a first range of cable diameters at the second opening when the volume it of cable sealing gel is pressurized. When the flap is removed from the main body of the volume of cable sealing gel, the volume of cable sealing gel is adapted to accommodate a second range of cable diameters at the second opening when the volume of cable sealing gel is pressurized. In another example, the volume of sealing gel includes first and second flaps that each extend about the second cable pass-through location and are located between the second cable pass-through location and the second end of the volume of cable sealing gel. At least one of the first and second flaps is removable from a main body of the volume of cable sealing gel. When the at least one flap is attached to the main body of the volume of cable sealing gel, the volume of cable sealing gel is adapted to accommodate a first range of cable diameters at the second cable pass-through location when the volume of cable sealing gel is pressurized. When the at least one flap is removed from the main body of the volume of cable sealing gel, the volume of cable sealing gel is adapted to accommodate a second range of cable diameters at the second cable pass-through location. The second range of cable diameters has a higher minimum and a higher maximum than the first range of cable diameters, but with it will be appreciated that the first and second ranges of cable diameters can overlap.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular examples of the present disclosure and therefore do not limit the scope of the present disclosure Examples of the present disclosure will hereinafter be described in conjunction with the appended drawings, wherein like numerals denote like elements.

FIG. 1 is a perspective view of a telecommunications enclosure in accordance with the principles of the present disclosure;

FIG. 2 is an enlarged view of FIG. 1 depicting a cable seal in accordance with the principles of the present disclosure latched within a pocket of the telecommunications enclosure of FIG. 1;

FIG. 3 is an exploded view of the telecommunications enclosure of FIG. 1;

FIG. 4 is a partial cut-away view of the telecommunications enclosure of FIG. 1;

FIG. 5 is an enlarged view of a portion of FIG. 4;

FIG. 6 is a first perspective view of the cable seal of the enclosure of FIG. 1;

FIG. 7 is a second perspective view of the cable seal of FIG. 6;

FIG. 8 is an exploded view of the cable seal of FIG. 6;

FIG. 9 is a front view of the cable seal of FIGS. 6-8;

FIG. 10 is an exploded cross-sectional view of an end portion of the telecommunications enclosure of FIG. 1;

FIG. 11 is another cross-sectional view of the end portion of the telecommunications enclosure of FIG. 1 with the cable seal installed within a pocket of the telecommunications enclosure and with a perimeter seal installed within a channel of the telecommunications enclosure;

FIG. 12 is an enlarged cross-sectional view showing the cable seal of FIGS. 6-8 installed within the pocket of the telecommunications enclosure and with a housing of the telecommunications enclosure closed;

FIG. 13 is in large cross-sectional view of FIG. 12 showing a sealing interface at a top side of the cable seal where the perimeter seal of the telecommunications enclosure extends across the top of the cable seal;

FIG. 14 is a perspective view of a configuration for a volume of cable sealing gel in accordance with the principles of the present disclosure;

FIG. 15 is a perspective view of another configuration for a volume of cable sealing gel in accordance with the principles of the present disclosure;

FIG. 16 is a perspective view of a further configuration for a volume of cable sealing gel in accordance with the principles of the present disclosure;

FIG. 17 is a perspective view of still another configuration for a volume of cable sealing gel in accordance with the principles of the present disclosure;

FIG. 18 shows the volume of cable sealing gel of FIG. 14 positioned between pressurization structures of a pressurization arrangement in accordance with the principles of the present disclosure;

FIG. 19 shows the volume of cable sealing gel of FIG. 15 positioned between pressurization structures of a pressurization arrangement in accordance with the principles of the present disclosure;

FIG. 20 shows the volume of cable sealing gel of FIG. 16 positioned between pressurization structures of a pressurization arrangement in accordance with the principles of the present disclosure;

FIG. 21 shows the volume of cable sealing gel of FIG. 17 positioned between pressurization structures of a pressurization arrangement in accordance with the principles of the present disclosure;

FIG. 22 is a perspective view of a volume of cable sealing gel in accordance with the principles of the present disclosure, the volume of cable sealing gel includes a removable flap;

FIG. 23 depicts the volume of cable sealing gel of FIG. 22 with the flap defining a lower end of the volume of cable sealing gel;

FIG. 24 depicts the volume of cable sealing gel of FIG. 22 with the flap removed;

FIG. 25 depicts another volume of cable sealing gel in accordance with the principles of the present disclosure, the volume of cable sealing gel includes two flaps;

FIG. 26 depicts the volume of cable seam gel of FIG. 25 with the flaps in the process of being wrapped in place with respect to a main body of the volume of cable sealing gel;

FIG. 27 depicts the volume of cable sealing gel of FIG. 25 with both of the flaps wrapped into place with respect to a main body of the volume of cable sealing gel;

FIG. 28 depicts the volume of cable sealing gel of FIG. 25 with an inner of the flaps removed; and

FIG. 29 depicts the volume of cable sealing gel of FIG. 28 with an outer of the flaps wrapped about a main body of the volume of cable sealing gel.

### DETAILED DESCRIPTION

Various examples will be described in detail with reference to the drawings, wherein like reference numerals represent like parts and assemblies throughout the several views.

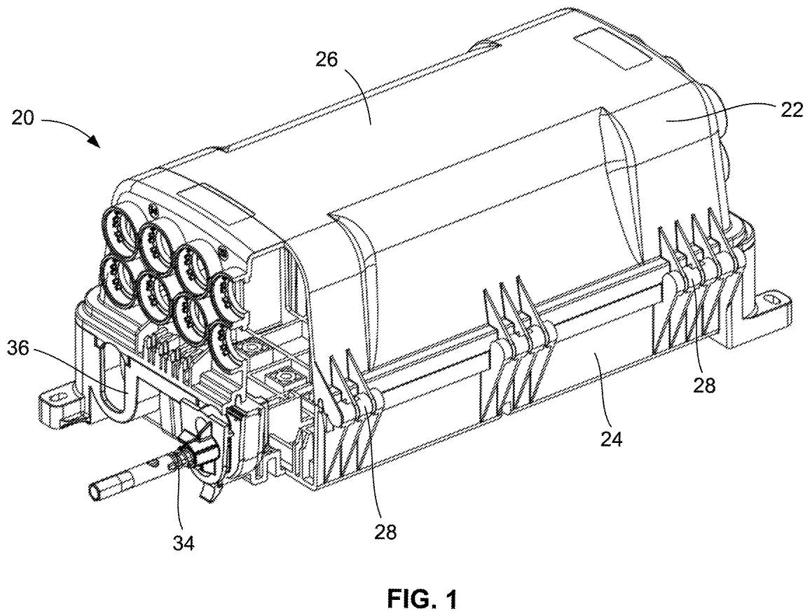

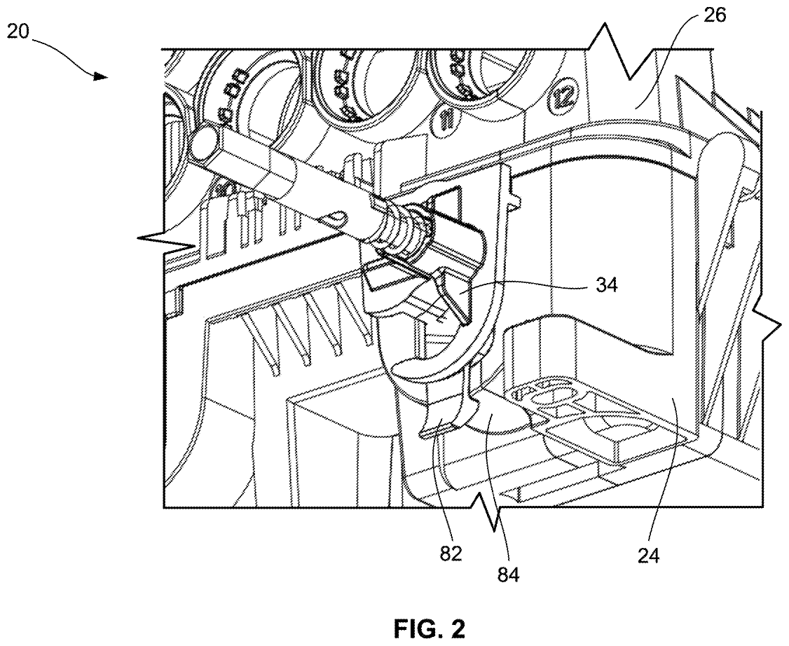

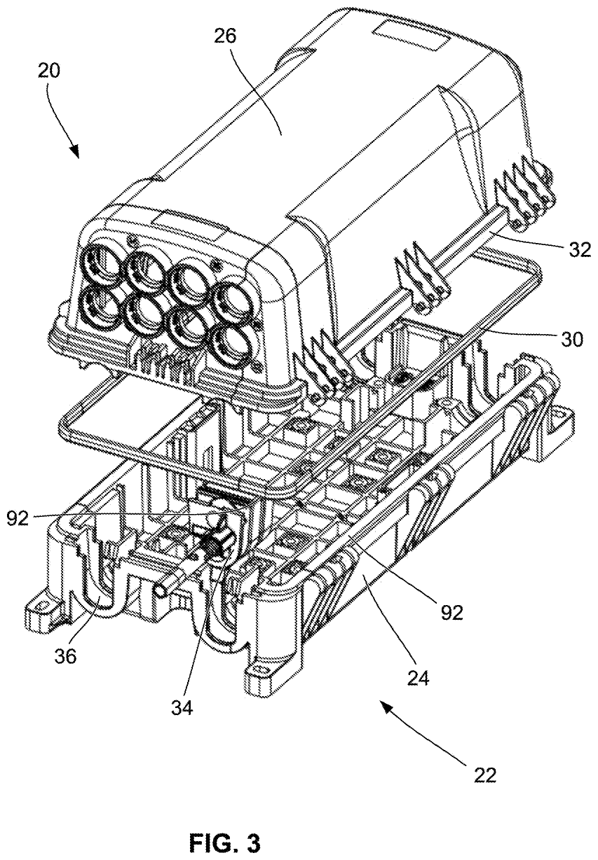

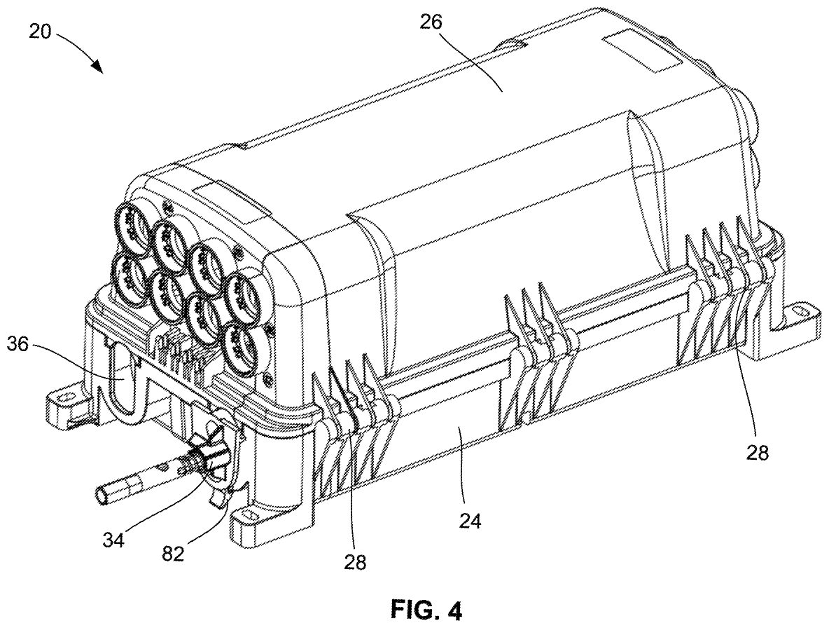

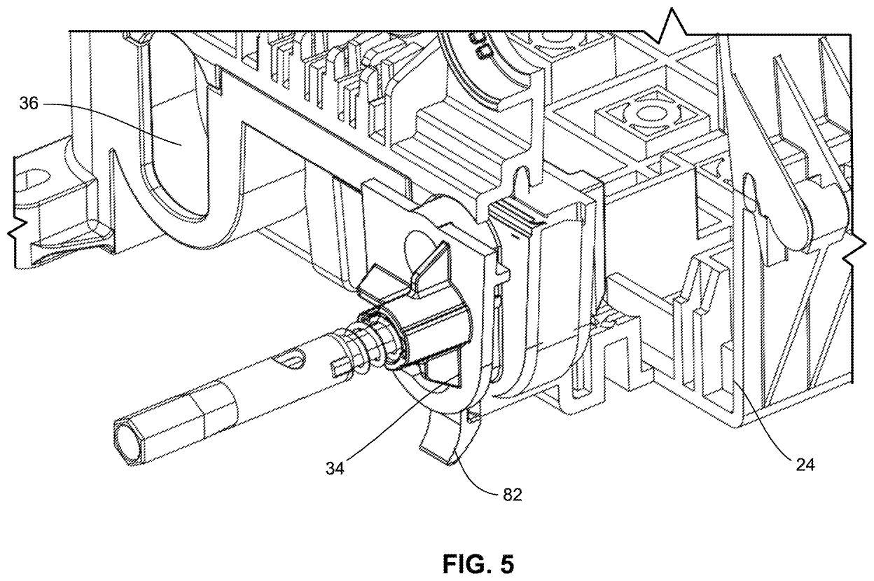

FIGS. 1-6 depict a telecommunications enclosure 20 in accordance with the principles of the present disclosure. The telecommunications enclosure 20 includes a housing 22 that is preferably environmentally sealed. The housing 22 includes a first housing piece 24 (e.g., a base) and a second housing piece 26 (e.g., a cover) that cooperate to define an interior of the housing 22. The first and second housing pieces 24, 26 can be separated from one another to allow the interior of the housing 22 to be accessed. In one example, the first and second housing pieces 24, 26 are coupled together by hinges 28 adapted for allowing the housing 22 to be opened and closed by pivoting the first and second housing pieces 24, 26 relative to one another. A perimeter seal 30 (e.g., a gasket) extends about a perimeter of the housing 22 at an interface between the first and second housing pieces 24, 26 for providing perimeter sealing between the first and second housing pieces 24, 26 when the housing 22 is closed. In one example, the perimeter seal 30 mounts within a channel 32 defined by the second housing piece 26. The telecommunications enclosure 20 also includes at least one cable seal 34 for sealing cables (e.g., fiber optic cables) routed into the interior of the housing 22. The cable seals 34 can be mounted within pockets 36 defined by the first housing piece 24. When the telecommunications enclosure 20 is assembled and the housing 22 is closed, the cable seals 34 mount within the pockets 36 and the perimeter seal 30 extends across and seals against top sides of the cable seals 34 that are mounted within the pockets 36. In a preferred example, the cable seals 34 can be pressurized within the pockets 36 to provide effective sealing about cables routed through the cable seals 34. When pressurized within the pockets 36, the cable seals 34 can form seals about cables routed through the cable seals 34 and can also seal about the perimeters of the cable seal 34 with respect to the portions of the housing 22 defining the pockets 36.

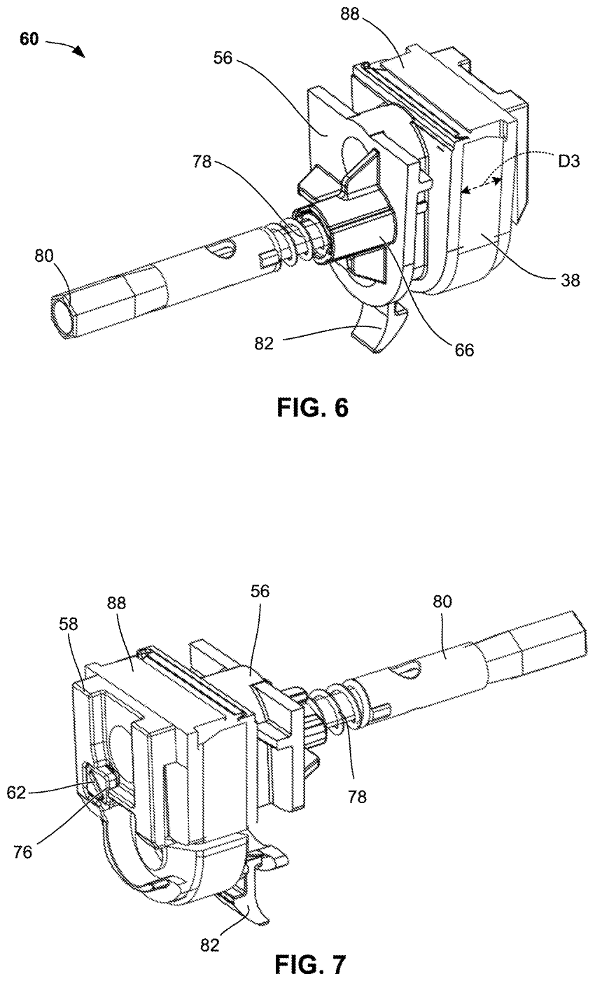

Referring to FIGS. 6-8, the cable seal 34 includes a volume of cable sealing gel 38 including a length L that extends along a first dimension D1 between opposite first and second ends 40, 42 of the volume of cable sealing gel 38. The volume of cable sealing gel 38 also includes a width W that extends along a second dimension D2 between opposite first and second sides 44, 46 of the volume of cable sealing gel 38. The volume of cable sealing gel 38 further includes a thickness T that extends along a third dimension D3 between the first and second major faces 48, 50 of the volume of cable sealing gel 38. The first dimension D1, the second dimension D2 and the third dimension D3 are all perpendicular relative to one another. The length L of the volume of cable sealing gel 38 is longer than the width W and the width W is longer than the thickness T. In the depicted example, the volume of cable sealing gel 38 includes first and second cable pass-through locations 52, 54 aligned along a reference line RL that extends along the first dimension D1. In the depicted examples, the first and second cable pass-through locations 52, 54 are depicted as openings. The third dimension D3 is parallel to cable pass-through axes 62, 64 defined by the cable pass-through locations 52, 54 and can be considered an axial dimension.

The cable seal 34 also includes a pressurization arrangement for pressurizing the volume of cable sealing gel 38 to provide effective sealing around cables passed through the cable pass-through locations 52, 54 and for providing perimeter sealing with the enclosure about at least a portion of the perimeter of the cable seal 34. The pressurization arrangement includes first and second pressurization plates 56, 58 for pressurizing the volume of cable sealing gel 38. The volume of cable sealing gel 38 is positioned between the first and second pressurization plates 56, 58 with the thickness T of the volume of cable sealing gel 38 extending between the first and second pressurization plates 56, 58. The first pressurization plate 56 is positioned adjacent the first major face 48 of the volume of cable sealing gel 38 and the second pressurization plate 58 is positioned adjacent the second major face 50 of the volume of cable sealing gel 38. The pressurization arrangement also includes an actuator 60 forcing the first and second pressurization plates 56, 58 together at an orientation along the third dimension D3 to cause the volume of cable sealing gel 38 to be pressurized between the first and second pressurization plates 56, 58. The actuator 60 includes an axial member 62 that extends through the first and second pressurization plates 56, 58 along the third dimension D3. The axial member 62 is configured to be tensioned as the volume of cable sealing gel 38 is pressurized. In the depicted example, the axial member 62 is offset from the reference line RL by an offset distance OD in a direction toward the second side 46 of the volume of cable sealing gel 38.

In the depicted example, the offset distance OD is measured from the reference line RL to a centerline 64 of the axial member 62. In one example, the offset distance OD is at least 10% of the width W of the volume of cable sealing gel 38. In another example, the offset distance OD is at least 15% of the width W of the volume of cable sealing gel 38. In the depicted example, the reference line RL is a centerline of the volume of cable sealing gel 38 and bisects the first and second cable pass-through locations 52, 54 and also bisects the volume of cable sealing gel 38.

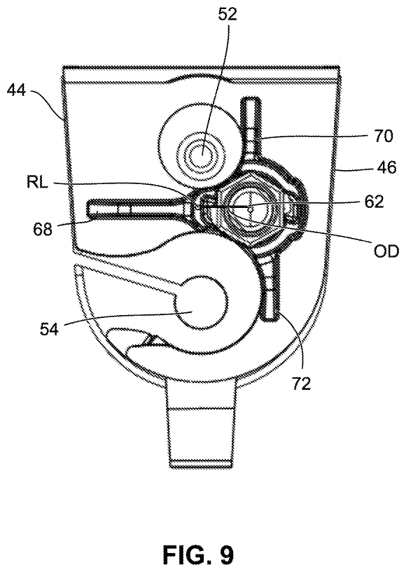

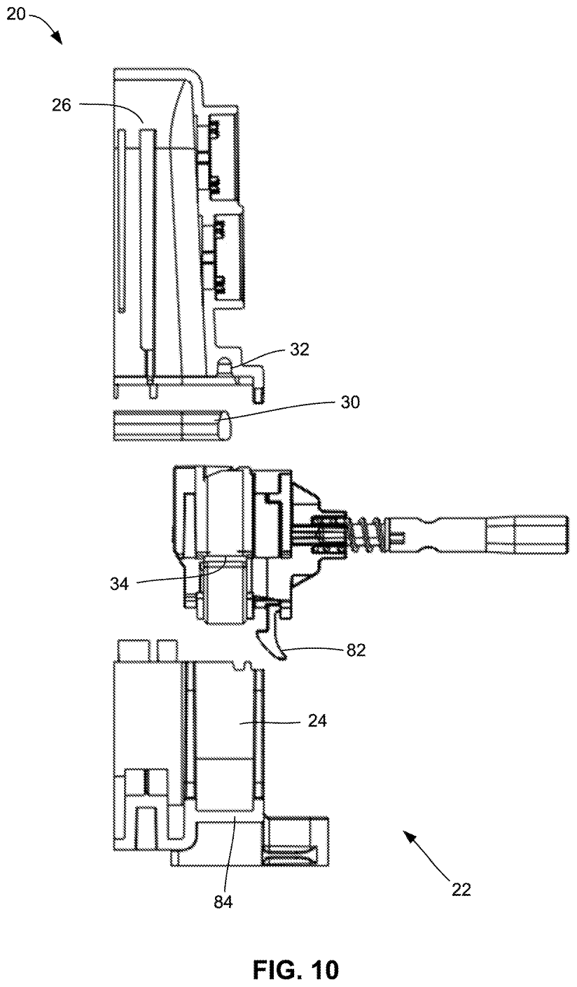

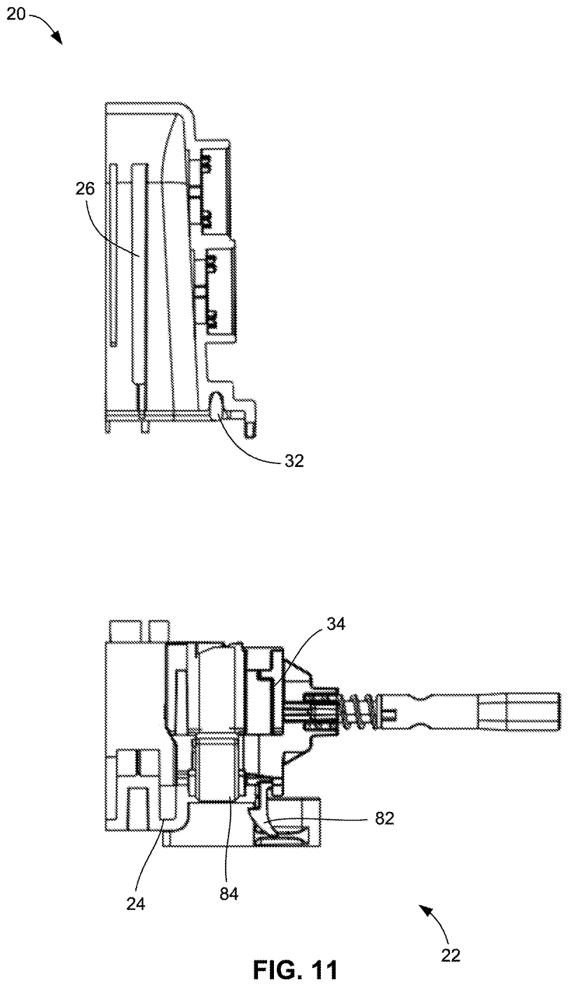

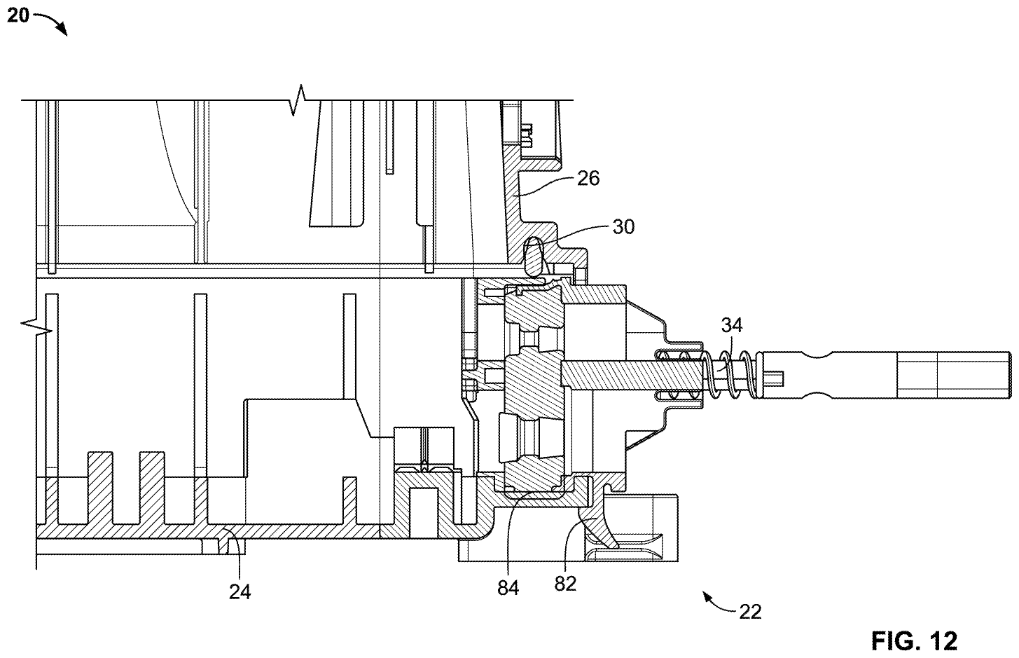

It is desirable for the volume of cable sealing gel 38 to be fairly uniformly pressurized by the actuator 60. To assist in more uniformly applying load to the volume of cable sealing gel, one or both of the first and second pressurization plates 56, 58 include integrated reinforcing structures adapted to assist in distributing loading more uniformly across the first and second major faces 48, 50 of the volume of cable sealing gel 38. In certain examples, the integrated reinforcing structures can have an asymmetrical configuration. In the depicted example, the reinforcing structure can include a boss 66 that surrounds the axial member 62 and that projects axially from the first pressurization plate 56. The integrated reinforcing structure can also include first, second and third gussets 68, 70, 72 integrated with the first pressurization plate 56 that project radially outwardly from the boss 66 and from the centerline 64 of the axial number 62. The first gusset 68 extends from the boss 66 along the second dimension D2 across the reference line RL. In the depicted example, the first gusset 68 extends between the first and second cable pass-through locations 52, 54 (as viewed from a front axial direction as shown at FIG. 9). A majority of a length of the first gusset 68 is located on an opposite side of the reference line RL from the centerline 64 of the axial member 62. The second gusset 70 extends from the boss 66 along the first dimension D1 in a direction toward the first end 40 of the volume of cable sealing gel 38. The third gusset 72 extends from the boss 66 along the first dimension D1 in a direction toward the second end 42 of the volume of cable sealing gel 38. The first gusset 68 is longer than each of the first and second gussets 70, 72. In one example, the first gusset 68 is at least 50% longer than each of the second and third gussets 70, 72.

In the depicted example, the axial member 62 is a bolt having a threaded end portion 74 that projects through the boss 66 of the first pressurization plate 56 and a head 76 positioned at the second pressurization plate 58. In one example, the head 76 fits within a receptacle defined by the second pressurization plate 58. Interference between the head 76 and the portion of the second pressurization plate 58 defining the receptacle prevents rotation of the bolt about the centerline 64. The actuator 60 includes a spring 78 mounted on the axial member 66 that extends into the interior of the boss 66 and abuts against a stop surface of the first pressurization plate 56. The actuator 60 also includes an actuation member 80 threaded on the threaded end portion 74 of the axial member 66. The spring 78 is captured between the actuation member 80 and the first pressurization plate 56 such that when the actuation member 80 is threaded in a first direction on the both the actuation member 80 compresses the spring 78 causing the bolt to be tensioned and the first and second pressurization plates 56, 58 to be forced together to pressurize the volume of cable sealing gel 38. When the actuation member 80 is threaded in a second direction opposite from the first direction with respect to the bolt, the spring 78 is allowed to de-compress on the volume of cable sealing gel 38 is de-pressurized.

In one example, the second end 42 of the volume of cable sealing gel 38 is rounded and the first end 40 of the volume of cable sealing gel 38 includes one or more planar surfaces that extend across the width W of the volume of cable sealing gel 38. In one example, the first and second sides 44, 46 of the volume of cable sealing gel 38 converges the first and second sides 44, 46 extend from the first end 40 or the second end 42 to provide the volume of cable sealing gel 38 with a tapered configuration. In one example, the first and second cable pass-through locations 52, 54 are the only cable pass-through locations defined by the volume of cable sealing gel 38.

It is preferred for the cable seal 34 to include a latch 82 for securing the cable seal 34 within its corresponding pocket 36 within the housing 22. In one example, the latch 82 is unitary formed with one of the first and second pressurization plates 56, 58. In the depicted example, the latch 82 is unitary formed with the first pressurization plate 56 and is located adjacent a front side of the first pressurization plate 56. It will be appreciated that the pocket 36 has a shape that generally matches or corresponds to the profile defined by the sides and rounded and of the volume of cable sealing gel 38. The cable seal 34 is installed within its corresponding pocket 36 when the housing is opened by inserting the cable seal 34 downwardly into the pocket 36 such that the second end 42 engages a corresponding rounded surface at the bottom end of the pocket 36 and the first and second sides 42, 44 engage corresponding tapered sides defining the pocket 36. When the cable seal 34 is inserted fully into its corresponding pocket 36, the latch 82 engages a corresponding catch 84 defined by the first housing piece 24. With the latch 82 engaged with the catch 84, the interlocked between the latch 82 and the catch 84 prevents the cable seal 34 from being withdrawn from the pocket 36 through the open top side of the pocket. If it is desired to remove the cable seal 34 from the pocket 36, the latch 82 can be unlatched by flexing the latch 82 away from the catch thereby enabling the cable seal to be withdrawn from the pocket 36.

It will be appreciated that the first and second pressurization plates 56, 58 are adapted to provide containment of the volume of cable sealing gel 38 at the first and second major faces 48, 50 of the volume of cable sealing gel 38. The first and second sides 44, 46 as well as the second end 42 of the volume of cable sealing gel 38 are exposed (e.g., not covered by the first and second pressurization plates 56, 58 such that the first and second sides 44, 46 as well as the second end 42 are configured for sealing against corresponding surfaces of the first housing piece 24 which defined the pocket 36 when the cable seal 34 is installed in the pocket 36. At least one of the first and second pressurization plates 56, 58 also includes an extension that overlaps the first end 40 of the volume of cable sealing gel 38 so as to provide containment of the volume of cable sealing gel 38 at the first end 40. In the depicted example, the first pressurization plate 56 includes a first extension 86 that extends over the first end 40 of the volume of cable sealing gel 38 and the second pressurization plate 58 includes a second extension 88 that extends over the first end 40 of the volume of cable sealing gel 38. In the depicted example, the second extension 88 has a continuous configuration with a length that extends continuously across the width W of the volume of cable sealing gel 38 and the first extension 86 has a segmented configuration with a plurality of separate segments positioned spaced apart from one another across the width W of the volume of cable sealing gel 38. In one example, the first and second extensions 86, 88 overlap one another and are configured to slide relative to one another as the actuator 60 is used to pressurize and depressurize the volume of cable sealing gel 38. In the depicted example, the second extension 88 is positioned over the first extension 86. In one example, the second pressurization plate 58 is adapted to interlock with the first housing piece 24 to prevent axial movement of the second pressurization plate 58 during pressurization of the volume of cable sealing gel 38. The second extension 88 is positioned over the first extension 86. The first extension slides under the second extension as the volume of cable sealing gel 38 is pressurized by the actuator 60.

In one example, when the cable seal 34 is installed within the pocket 36, slight gaps are located between the ends of the lengths of the extensions 86, 88 and the sides of the pocket 36 such that when the volume of cable sealing gel 38 is pressurized within the pocket 36 a small portion of the volume of cable sealing gel 38 can extrude upwardly into triple point regions 90 located at the sides of the pocket 36.

The perimeter seal 30 is positioned within the channel 32 and forms perimeter sealing about the perimeter of the housing 22 when the housing 22 is closed. For example, the perimeter seal 30 seals against a sealing surface 92 that extends around the perimeter of the housing 22. It will be appreciated that the sealing surface 92 defined by the first housing piece 24 is interrupted at the pockets 36 (i.e., the sealing surface 92 does not extend across the pockets 36). Instead, with the cable seals 34 installed in the pockets 36, the perimeter seal 30 extends across the top sides of the cable seals 34 and seals against the second extensions 88. It is preferred for the second extensions 88 to have a plastic construction and to be relatively stiff to assist in providing containment of the volume of cable sealing gel 38 and to provide an effective sealing surface against which the perimeter seal 30 can effectively seal. It will be appreciated that the triple point regions 90 are the locations where the perimeter seal 30 transitions from the sealing surface 92 of the first housing piece 24 to the top sides of the second extensions 88.

In one example, the latch 82 combined with the gel containment provided by the first and second pressurization plates 56, 58 allows the volume of cable sealing gel 38 to be pressurized by the actuator 60 when the cable seal 34 is latched within the pocket 36 regardless of whether the first and second housing pieces 24, 26 are secured together or not. In one example, the volume of cable sealing gel 38 can be pressurized within the pocket 36 and can remain pressurized within the pocket 36 even when the housing 22 is opened. Containment of the volume of cable sealing gel 38 is provided by the main bodies of the first and second pressurization plates 56, 58 adjacent the first and second major faces 48, 50 of the volume of cable sealing gel 38. Containment of the volume of cable sealing gel 38 is also provided at the first end 40 of the volume of cable sealing gel 38 by the first and second extensions 86, 88. Containment of the volume of cable sealing gel 38 is further provided about the first and second sides 44, 46 and the second end 42 of the volume of cable sealing gel 38 by the pocket 36-defining portion of the first housing piece 24. The pocket 36 defining portion of the first housing piece 24 includes a surface or surfaces which opposes the first and second sides 44, 46 and the second end 42 of the volume of cable sealing gel 38. The first and second sides 44, 46 and the second end 42 of the volume of cable sealing gel 38 seal against the pocket 36 defining portions of the first housing piece 24. The latch 82 also assists in preventing the cable seal 34 from being depressurized when the housing 22 is opened by preventing the cable seal 34 from moving upwardly within the pocket 36 upon opening of the housing 22.

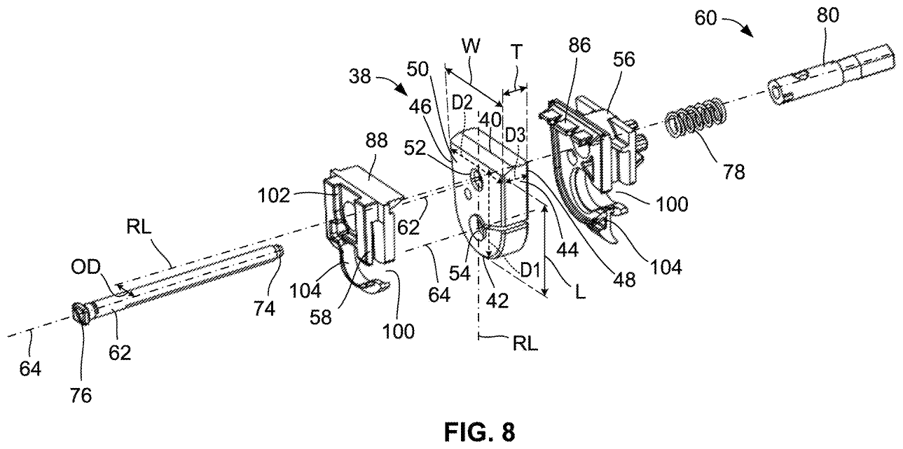

One example, the cable seal 34 and have a wrap-around configuration that allows a cable to be laterally inserted into the second cable pass-through location 54 rather than requiring the cable to be inserted axially through the second cable pass-through location 54. To provide the wrap-around configuration, both the first and second pressurization plates 56, 58 as well as the volume of cable sealing gel 38 can have a slotted or open sided configuration for accommodating lateral insertion of a cable into the second cable pass-through location 54. Referring to FIG. 8, the first and second pressurization plates 56, 58 are shown each including a side access slot 100 corresponding to the second cable pass-through location 54 for allowing a cable to be inserted laterally into the second cable pass-through location 54 without interference from the first and second pressurization plates 56, 58. The first and second pressurization plates 56, 58 can each include a main body 102 and an extension finger 104 that projects from the main body 102. The extension fingers 104 can be located adjacent the bottom of the cable seal 34 and can wrap partially around the second cable pass-through location 54. The side access slot 100 can be defined between the extension fingers 104 of the first and second pressurization plates 56, 58 and the main bodies 102 of the first and second pressurization plates 56, 58.

In certain examples, volumes of cable sealing gel in accordance with the principles of the present disclosure can have lateral cable access features adapted to interlock with the first and second pressurization plates to facilitate retaining lateral cable access features of the volumes of cable sealing gel in a closed position. For example, the lateral cable access features can axially interlock with the first and/or second pressurization plates to retain the lateral cable access features in a wrapped-around configuration but can be axially disengaged from the first and/or second pressurization plate to allow the lateral cable access feature to be moved from the wrapped-around configuration to an open, cable-receiving position.

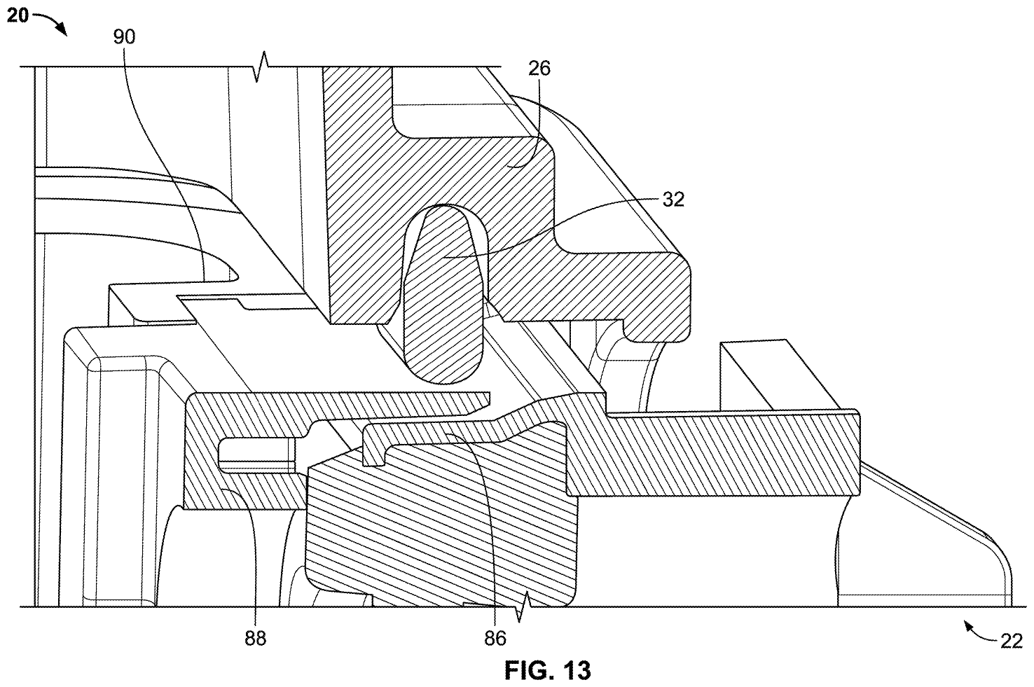

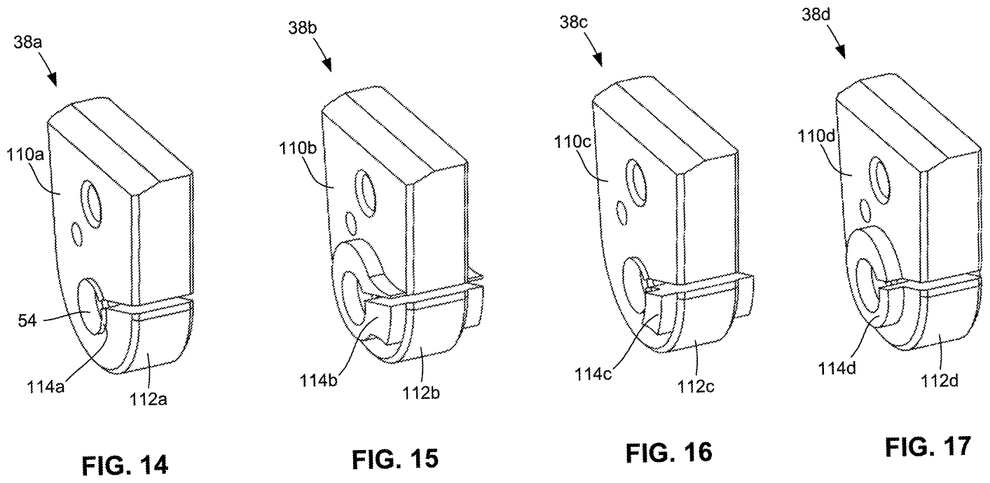

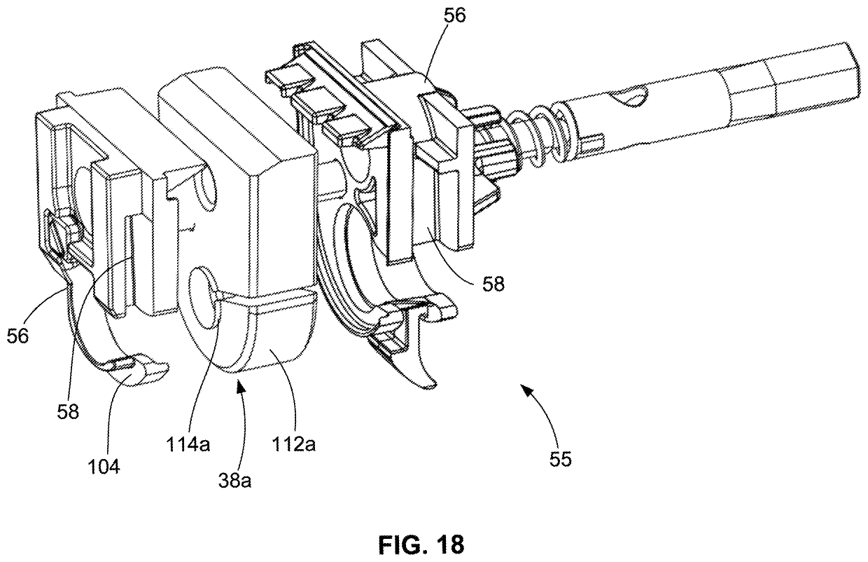

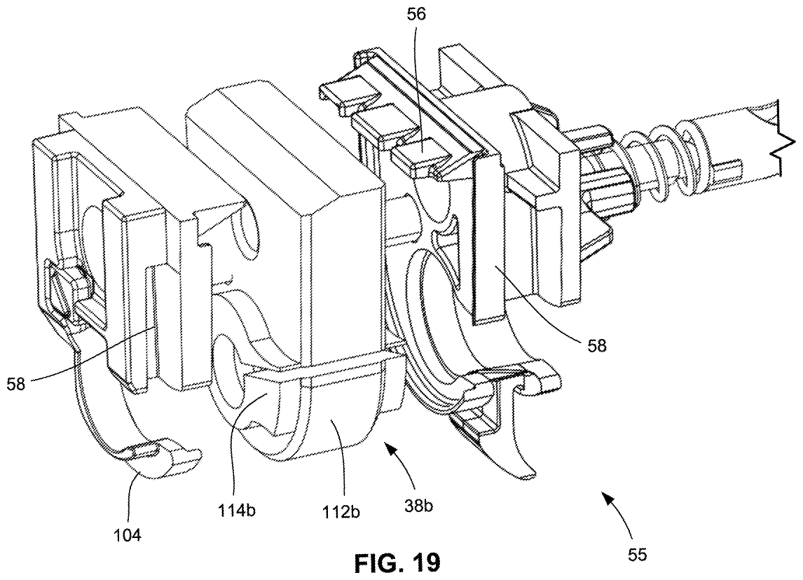

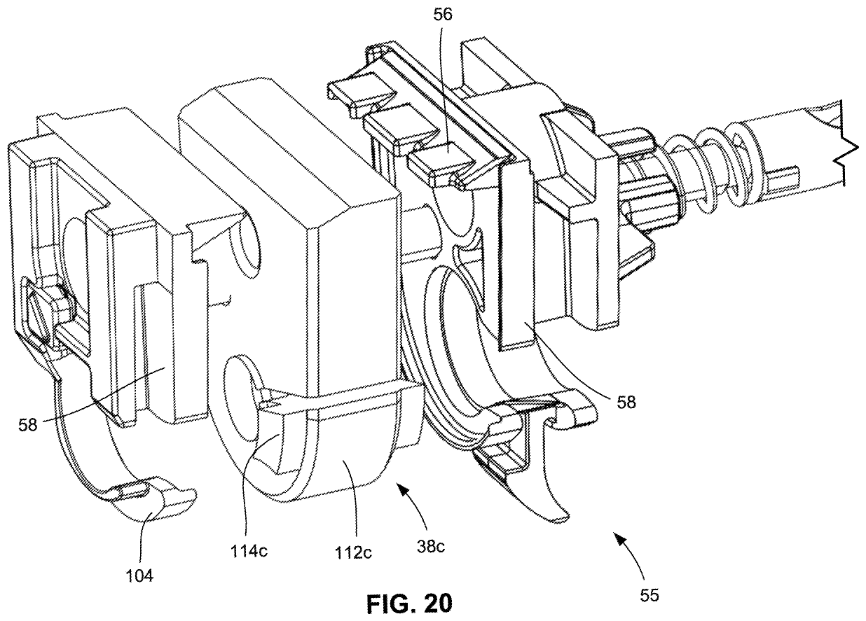

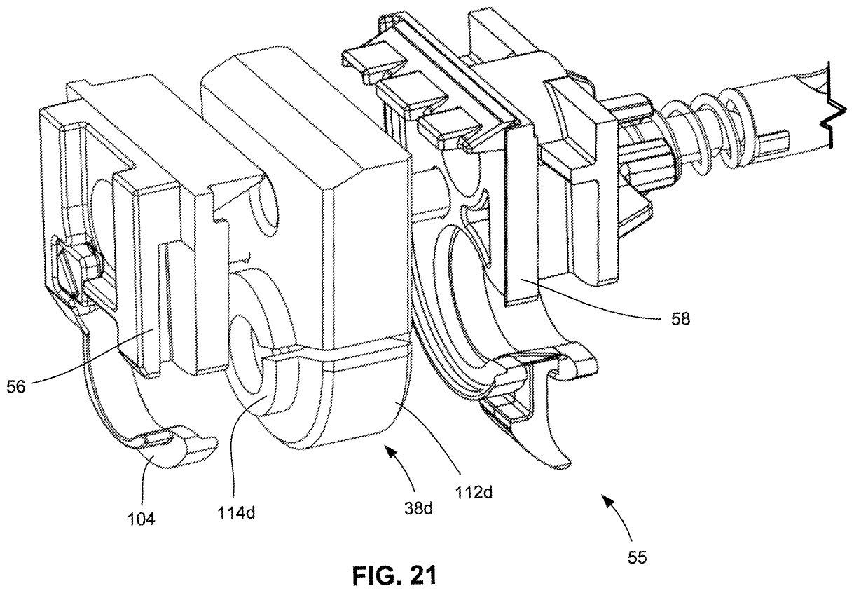

FIGS. 14-17 depict example volumes of cable sealing gel 38a-38d having lateral cable access features with interlocks in accordance with the principles of the present disclosure. Each of the volumes of cable sealing gel 38a-38d can be used in combination with a pressurization arrangement including an actuator such as the pressurization arrangement 55 including the first and second pressurization plates 56, 58 and the actuator 60. FIGS. 18-21 show the volumes of cable sealing gel 38a-38d each assembled with the pressurization arrangement 55.

Referring to FIGS. 14-17, each of the volumes of cable sealing gel 38a-38d includes a main body portion 110a-110d and an access portion 112a-112d coupled to the main body portion 110a-110d. Each of the access portions 112a-112d defines a portion of the second cable pass-through location 54 and is capable of being flexed away from the corresponding main body portion 110a-110d from a first position (e.g., closed or wrapped-around configuration) to a second position (e.g., an open or nonwrapped-around position or cable access position) to provide lateral cable access to the second cable pass-through location 54. The access portions 112a-112d include interlock portions 114a-114d that axially overlap and interlock with features of at least one of the first and second pressurization plates 56, 58 to facilitate retaining the access portions 112a-112d in the first positions when the volumes of cable sealing gel 38a-38d are assembled between the first and second pressurization plates 56 and 58 of a pressurization assembly. In one example, the interlock portions 114a-114d are configured to interlock with the extension finger 104 of at least one of the first and second pressurization plates 56, 58. In one example, the interlock portions 114a-114d are provided at both the first and second major faces of each of the volumes of cable sealing gel 38a-38d and interlock with the extension fingers 104 of both the first and second pressurization plates 56, 58. The interlock portions 114a-114d can have different shapes such as a lip surrounding the second cable pass-through location (e.g., see interlock portion 114a of FIG. 14), a tab projecting laterally from a curved wall that extend about the second cable pass-through location (e.g., see interlock portion 114b of FIG. 15), a tab adjacent a free end of the access portion and a lip extending about the second cable pass-through location (e.g., see interlock portion 114c of see FIG. 16), and a curved wall surrounding the second cable pass-through location (e.g., see interlock portion 114d of FIG. 17). In certain examples, the interlock portions also include sections located on the main body of the volume of sealing gel that assist in generally positioning and retaining the main body at a desired position between the pressurization plates.

It will be appreciated that the volumes of cable sealing gel 38a-38d and thus the access portions 112a-112d and the interlock portions 114a-114d are resilient and deformable. While the volumes of cable sealing gel 38a-38d are assembled between the pressurization plates 56, 58, the access portions 112a-112d can be manually moved from the second positions to the first positions by manually pressing the access portions 112a-112d laterally inwardly between the pressurization plates 56, 58. It will be appreciated that the interlock portions 114a-114d are resiliently deformable in an axial direction. Thus, as the access portions 112a-112d are pressed between the pressurization plate 56, 58 in a direction toward the first positions, the interlock portions 114a-114d contact the extension fingers 104 of the pressurization plates 56, 58 causing the interlock portions 114a-114d to deform in an axial direction from their normal shape to a deformed shape to allow the interlock portions to clear and move past the fingers 104. Once the interlock portions 114a-114d move past the fingers 104, the interlock portions 114a-114d resiliently return to their normal shape to a state in which the interlock portions 114a-114d axially overlap and interlock with the fingers 104 such that interference between the interlock portions 114a-114d and the fingers 104 resists lateral/radial movement of the access portions 112a-112d from the first positions toward the second positions. To move the access portions 112a-112d laterally from the first positions back to the second positions, the access portions 112a-112d can be manually pulled laterally outwardly from between the pressurization plates 56, 58 causing the interlock portions 114a-114d to contact the extension fingers. Contact between the interlock portions 114a-114d and the fingers 104 causes the interlock portions 114a-114d to axially deform from their normal shape to the deformed shape to allow the interlock portions to clear and move past the fingers 104 as the access portions 112a-112d are pulled laterally out from between the pressurization plates 56, 58.

To laterally load a cable into the second cable passthrough location of the cable seal, the cable seal is depressurized and removed from the pocket of the enclosure. A plug can be removed from the second cable pass-through location and the access portion of the volume of gel of the cable seal can be laterally pulled outwardly from between the pressurization plates from the first position to the second position. With the access portion in the second position, the cable can be loaded laterally though the side access slots of the pressurization plates into the second cable pass-through location. The access portion can then be moved from the second position laterally back to the first position to wrap around the cable within the second cable pass-through location and captured the capture the cable within the second cable pass-through location. Once moved to the second position, the interlock assists in retaining the access portion in the first position.

To laterally unload a cable from the second cable passthrough location of the cable seal, the cable seal is depressurized and removed from the pocket of the enclosure. The access portion of the volume of gel of the cable seal can then be laterally pulled outwardly from between the pressurization plates from the first position to the second position. With the access portion in the second position, the cable can be unloaded from the second cable pass-through location laterally though the side access slots of the pressurization plates.

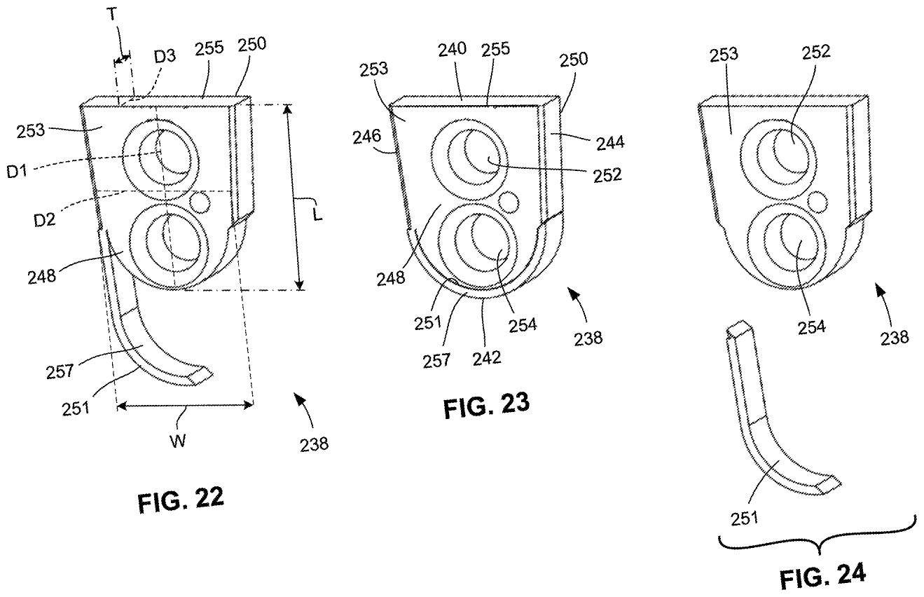

Referring to FIGS. 22-24, an alternative volume of sealing gel 238 in accordance with the principles of the present disclosure is depicted. The volume sealing gel 238 is adapted to be used in combination with pressurization arrangements in accordance with the principles of the present disclosure (e.g., in place of the sealing volume of cable sealing gel 38). The sealing gel 238 has a configuration that allows the volume of sealing gel to be adjusted to accommodate different cable sizes (e.g., different ranges of cable diameters). The volume of sealing gel 238 has a length L that extends along a first dimension D1 between opposite first and second ends 240, 242 of the volume of sealing gel 238, a width W that extends along a second dimension D2 between opposite first and second sides 244, 246 of the volume of sealing gel 238, and a thickness T that extends along a third dimension D3 between first and second major faces 248, 250 of the volume of sealing gel 238. The first, second and third dimensions D1-D3 are perpendicular relative to one another. The length L being longer than the width W and the width W is longer than the thickness T. The volume of sealing gel 238 includes first and second cable pass-through locations 252, 254 aligned along a reference line RL that extends along the first dimension D1. In one example, the second end 242 of the volume of sealing gel 238 is rounded and the first and second sides 244, 246 of the volume of sealing gel 238 converge as the first and second sides 244, 246 extend from the first end 240 toward the second end 242 to provide the volume of sealing gel 238 with a tapered configuration.

The volume of sealing gel 238 includes a flap 251 that extends about the second cable pass-through location 254 and is located between the second cable pass-through location 254 and the second end 242 of the volume of sealing gel 238. The flap 251 is removeable from a main body 253 of the volume of sealing gel 238. For example, the flap 251 can have a base end 255 unitarily connected with the main body 253 and a free end 257 opposite from the base end 255. The flap 251 can be completely removed by tearing the flap 251 from the main body 253 at the base end 255 to provide a reduction in gel volume. In other examples, only a segment of the flap 251 can be removed to reduce the volume of gel by an intermediate amount. When the flap 251 is attached to the main body 253 the volume of sealing gel 238 is adapted to accommodate a first range of cable diameters at the second cable pass-through location 254 when installed in the pressurization arrangement. When the flap 251 is removed from the main body 253 (see FIG. 24), the volume of sealing gel 238 is adapted to accommodate a second range of cable diameters at the second cable pass-through location 254 when installed in the pressurization arrangement. The second range of cable diameters has a higher minimum and a higher maximum than the first range of cable diameters, but with it will be appreciated that the first and second ranges of cable diameters can overlap. By removing only a portion of the flap 251, an intermediate range of cable diameters may be accommodated when the gel is used with the pressurization arrangement.

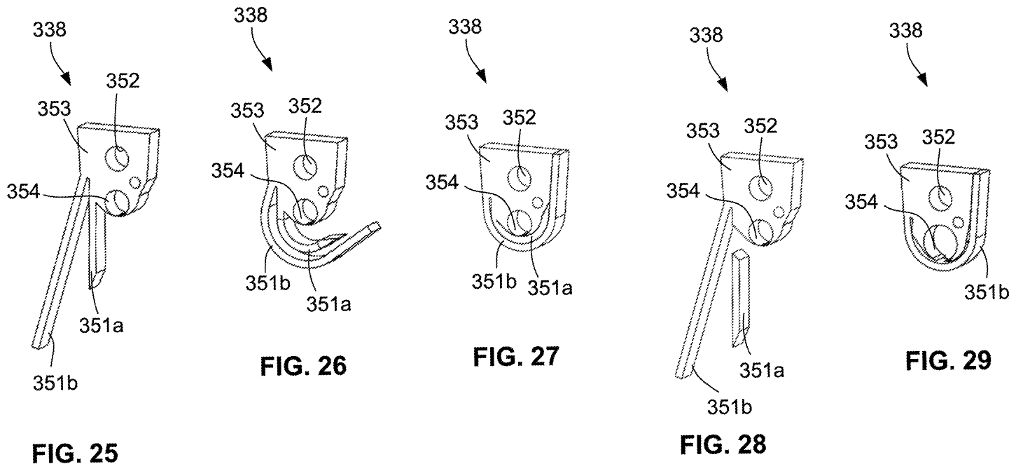

FIGS. 25-29 depict another volume of sealing gel 338 usable with a pressurization arrangement of the type disclosed herein that is similar to the volume of sealing gel 238 except the volume of sealing gel 338 includes two flaps 351a, 351b instead of one. The volume of sealing gel 338 includes first and second cable pass-through locations 352, 354. The flaps are inner and outer flaps 351a, 351b that overlap one another. At least one of the first and second flaps 351a, 351b is removeable from a main body 353 of the volume of sealing gel 338 (e.g., the inner flap 351a is depicted as being removed at FIGS. 28 and 29). When both inner and outer flaps 351a, 351b are attached to the main body 353 (see FIGS. 25-27), the volume of sealing gel 338 is adapted to accommodate a first range of cable diameters at a second cable pass-through location 354. When one of the flaps 351a, 351b is removed from the main body 353 the volume of sealing gel 338 is adapted to accommodate a second range of cable diameters at the second cable pass-through location 354. The second range of cable diameters has a higher minimum and a higher maximum than the first range of cable diameters, but with it will be appreciated that the first and second ranges of cable diameters can overlap.

In the depicted examples, the actuator has an offset from center positioning relative to the pressurization plates and/or the volume of sealing gel. In other examples the actuator can have a centered configuration and can incorporate other features disclosed herein (e.g., the top gel cover integrated with at least one of the pressurization plates (e.g., top extensions), the wrap around design with interlock or removeable wrap around flaps to adjust gel volume, or the cable seal latch). In certain examples, the cable pass-through locations can be openings. When no cable is present at an opening forming a cable pass-through location, the opening can be filled with plugs. In certain examples, the plugs can be separate pieces from the volume of cable sealing gel or can be portions of gel integrated with main bodies of the volumes of cable sealing gel that can be torn away or otherwise removed from the main bodies of gel to open the pass-through locations.

1. A cable seal adapted to be mounted in a pocket of an enclosure, the cable seal comprising:
a volume of sealing gel including a length that extends along a first dimension between opposite first and second ends of the volume of sealing gel, a width that extends along a second dimension between opposite first and second sides of the volume of sealing gel, and a thickness that extends along a third dimension between first and second major faces of the volume of sealing gel, the first, second and third dimensions being perpendicular relative to one another, the length being longer than the width and the width being longer than the thickness;
the volume of sealing gel including first and second cable pass-through locations aligned along a reference line that extends along the first dimension;
first and second pressurization plates for pressurizing the volume of sealing gel, the volume of sealing gel being positioned between the first and second pressurization plates with the thickness of the volume of sealing gel extending between the first and second pressurization plates, the first pressurization plate being positioned adjacent the first major face of the volume of sealing gel and the second pressurization plate being positioned adjacent the second major face of the volume of sealing gel; and
an actuator for forcing the first and second pressurization plates together in an orientation along the third dimension to cause the volume of sealing gel to be pressurized between the first and second pressurization plates, the actuator including an axial member that extends through the first and second pressurization plates along the third dimension that is tensioned as the volume of sealing gel is pressurized, the axial member being offset from the reference line an offset distance in a direction toward one of the first and second sides of the volume of sealing gel.

2. The cable seal of claim 1, wherein the offset distance is measured from the reference line to a centerline of the axial member, and wherein the offset distance is at least 10 percent of the width of the volume of sealing gel.

3. The cable seal of claim 2, wherein the offset distance is at least 15 percent of the width of the volume of sealing gel.

4. The cable seal of claim 1, wherein the first pressurization plate includes a boss that surrounds the axial member, and a first gusset that extends from the boss along the second dimension across the reference line.

5. The cable seal of claim 4, wherein a majority of a length of the first gusset is located on an opposite side of the reference line from a centerline of the axial member.

6. The cable seal of claim 5, further comprising a second gusset that extends from the boss along the first dimension in a direction toward the first end of the volume of sealing gel and a third gusset that extends from the boss along the first dimension in a direction toward the second end of the volume of sealing gel, the first gusset being longer than each of the second and third gussets.

7. The cable seal of claim 6, wherein the axial member is a bolt having threaded end that projects through the boss of the first pressurization plate and a head positioned at the second pressurization plate, wherein the actuator includes a spring mounted on the bolt that extends into the boss, and wherein the actuator includes a actuation member threaded on the threaded end of the bolt with the spring captured between the actuation member and the first pressurization plate, wherein when the actuation member is threaded in a first direction on the bolt the actuation member compresses the spring causing the bolt to be tensioned and the first and second pressurization plates to be forced together to pressurize the volume of sealing gel, and wherein when the actuation member is threaded in a second direction on the bolt the spring is allowed to de-compress and the volume of sealing gel is de-pressurized.

8. The cable seal of claim 6, wherein the reference line bisects the volume of sealing gel.

9. The cable seal of claim 1, wherein the second end of the volume of sealing gel is rounded and wherein the first and second sides of the volume of sealing gel converge as the first and second sides extend from the first end toward the second end to provide the volume of sealing gel with a tapered configuration.

10. The cable seal of claim 8, wherein first and second cable pass-through locations are the only cable pass-through locations defined by the volume of sealing gel.

11. The cable seal of claim 1, wherein at least one of the first and second pressurization plates includes a latch for retaining the cable seal in the pocket of the enclosure.

12. The cable seal of claim 1, wherein the first side, the second side and the second end of the volume of sealing gel are exposed provide sealing with the enclosure about a perimeter of the volume of sealing gel, and wherein the at least one of the first and second pressurization plates includes an extension that overlaps the first end of the volume of sealing gel.

13. The cable seal of claim 1, wherein the first side, the second side and the second end of the volume of sealing gel are exposed provide sealing with the enclosure about a perimeter of the volume of sealing gel, and wherein the first and second pressurization plates respectively include first and second extensions that overlap one another and cover the first end of the volume of sealing gel.

14. The cable seal of claim 13 wherein the second pressurization plate is adapted to interlock with the enclosure to prevent axial movement of the second pressurization plate during pressurization of the volume of sealing gel, wherein the second extension of the second pressurization plate is positioned over the first extension of the first pressurization plate, wherein the first extension of the first pressurization plate slides under second extension of the second pressurization plate as the volume of gel is pressurized by the actuator.

15. The cable seal of claim 14, wherein the first extension of the first pressurization plate is segmented and the second extension of the second pressurization plate is continuous.

16. The cable seal of claim 14, wherein the enclosure includes a housing having first and second housing pieces that cooperate to define an interior of the housing, wherein the pocket is defined by the first housing piece, and wherein a perimeter seal for sealing between the first and second housing pieces extends about a perimeter of the housing and across the second extension of the second pressurization plate.

17. The cable seal of claim 1, wherein the volume of sealing gel includes a main body and an access portion coupled to the main body, the access portion defining a portion of the second cable pass-through location and being capable of being flexed away from the main body from a first position to a second position to provide lateral cable access to the second cable pass-through location, the access portion including a deformable interlock portion that axially overlaps with a feature of at least one of the first and second pressurization plates to facilitate retaining the access portion in the first position when the volume of sealing gel is assembled between the first and second pressurization plates, wherein the first and second pressurization plates include side access slots corresponding to the second cable pass-through location for allowing a cable to be inserted laterally into the second pass-through location when the cable access portion is flexed away from the main body to the second position, and wherein when the volume of sealing gel is depressurized the cable access potion can be manually moved between the first and second positions relative to the main body and relative to the first and second pressurization plates.

18. The cable seal of claim 17, wherein the interlock portion includes a first section on the access portion and a second section on the main body portion.

19. The cable seal of claim 18, where the interlock portion include a first interlock portion at the first major face of the volume of sealing gel adapted to interlock with the first pressurization plate and a second interlock portion at the second major face of the volume of sealing gel adapted to interlock with the second pressurization plate.

20. The cable seal of claim 9, wherein the volume of sealing gel includes a flap that extends about the second cable pass-through location and is located between the second cable pass-through location and the second end of the volume of sealing gel, wherein at least a segment of a length of the flap can be removed to adjust the volume of the sealing gel.

21. The cable seal of claim 9, wherein the volume of sealing gel includes a flap that extends about the second cable pass-through location and is located between the second cable pass-through location and the second end of the volume of sealing gel, wherein the flap is removeable from a main body of the volume of sealing gel, wherein when the flap is attached to the main body the volume of sealing gel is adapted to accommodate a first range of cable diameters at the second cable pass-through location, and wherein when the flap is removed from the main body the volume of sealing gel is adapted to accommodate a second range of cable diameters at the second cable pass-through location.

22. The cable seal of claim 9, wherein the volume of sealing gel includes first and second flaps that each extend about the second cable pass-through location and are located between the second cable pass-through location and the second end of the volume of sealing gel, wherein at least one of the first and second flaps is removeable from a main body of the volume of sealing gel, wherein when the at least one flap is attached to the main body the volume of sealing gel is adapted to accommodate a first range of cable diameters at the second cable pass-through location, and wherein when the at least one flap is removed from the main body the volume of sealing gel is adapted to accommodate a second range of cable diameters at the second cable pass-through location.

23-40. (canceled)
